(19) United States
(12) Patent Application Publication
(10) Pub. No.: US 2007/0070398 A1
(43) Pub. Date: Mar. 29, 2007

(54) Scanner and error display method for the same

(75) Inventor: Akihide Oshima, Saitama (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/354,158

(22) Filed: Feb. 15, 2006

(30) Foreign Application Priority Data
Sep. 22, 2005 (JP) 2005-276028

(51) Int. Cl. G06F 3/12

(52) U.S. Cl. 358/1.15; 358/474; 358/1.13

(57) ABSTRACT

A scanner which is network connected or locally connected to a printer and outputs a read-out image to the printer as a copying job for carrying out a printing request, and which includes an error display section; an error code acquisition section which acquires a printer model-specific error code set for each model of the printer from the printer, an error code conversion section which converts the error code acquired by the error code acquisition section into error information which can be displayed on the error display section; and a display control section which, on the basis of the error information converted by the error code conversion section, displays an error occurred in the printer on the error display section

### BACKGROUND OF THE INVENTION

1. Field of the Invention

The present invention relates to a scanner which is network connected or locally connected to a printer, and outputs a read-out image to the printer as a copying job for carrying out a printing request, thereby realizing the copying function, and an error display method for the same, and particularly to a scanner which is adapted to display the content of a printer error on the display section of the scanner, and an error display method for the same.

2. Description of the Related Art

Recently, a system which network connects or locally connects a scanner to a printer, and outputs an image read out by the scanner to the printer as a copying job, thereby realizing the copying function not through a personal computer has been proposed.

In such a system, if a fault occurs in the printer, the scanner side generally cannot recognize this fault in the printer, which is inconvenient to the user who intends to implement the copying function using a scanner.

In other words, it is impossible to detect, on the scanner side, whether the trouble which has occurred when the copying function of the scanner is used is due to the scanner side or the printer side.

As the technique which outputs image data read out by the scanner to the printer as a printing job for printing the read-out image, the “Printing apparatus” as described in Japanese Patent Application Laid-Open No. 2004-009499 is available.

However, with the “Printing apparatus” as described in Japanese Patent Application Laid-Open No. 2004-009499, detailed information on a printer error occurred on the printer side when the scanner outputs a copying job to the printer cannot be displayed at the scanner side, because the printer error, that is, the type of error code varies depending upon the model of the printer.

### SUMMARY OF THE INVENTION

An aspect of the present invention provides a scanner which is network connected or locally connected to a printer, and outputs a read-out image to the printer as a copying job for carrying out a printing request, and which includes: an error display section; an error code acquisition section which acquires from the printer a printer model-specific error code set for each model of the printer; an error code conversion section which converts the error code acquired by the error code acquisition section into error information which can be displayed on the error display section; and a display control section which, on the basis of the error information converted by the error code conversion section, displays an error occurred in the printer on the error display section.

Another aspect of the present invention provides a scanner which is network connected or locally connected to a printer, and outputs a read-out image to the printer as a copying job for carrying out a printing request, and which includes: an error display section; an error display information acquisition section which acquires, from the printer, error display information which is displayed on the basis of the printer model-specific error code which has been set in the printer for each model of the printer; and a display control section which, on the basis of the error information acquired by the error display information acquisition section, displays an error occurred in the printer on the error display section.

Still another aspect of the present invention provides an error display method for a scanner which is network connected or locally connected to a printer, and outputs a read-out image to the printer as a copying job for carrying out a printing request, the method includes: acquiring from the printer, by using an error code acquisition section, a printer model-specific error code set for each model of the printer, converting, by using an error code conversion section, the error code acquired by the error code acquisition section into error information which can be displayed on an error display section; and on the basis of the error information converted by the error code conversion section, displaying by using a display control section an error occurred in the printer on the error display section.

Still another aspect of the present invention provides an error display method for a scanner which is network connected or locally connected to a printer, and outputs a read-out image to the printer as a copying job for carrying out a printing request, the method includes: acquiring from the printer, by using an error display information acquisition section, error display information which is displayed on the basis of the printer model-specific error code which has been set in the printer for each model of the printer; and on the basis of the error information acquired by the error display information acquisition section, displaying by using a display control section an error occurred in the printer on the error display section.

### BRIEF DESCRIPTION OF THE DRAWINGS

FIG. 1A and 1B are image drawings illustrating the outline of the scanner and the error display control in the scanner of the present invention;

FIG. 2 is a drawing illustrating an example of configuration of the scanner and the printer as shown in FIG. 1A and 1B;

FIG. 3 is a drawing illustrating an example of error code conversion table;

FIG. 4 is a drawing illustrating an example of error code list which is notified to the scanner from the printer;

FIG. 5A and FIG. 5B are drawings illustrating examples of status information notified to the scanner from the printer;

FIG. 6 is a drawing illustrating an example of printer model management information;

FIG. 7 is a flowchart illustrating an example of operation of the scanner when it senses the connection of the printer; and

FIG. 8 is a flowchart illustrating an example of operation of the printer error display processing after the error display mode having been established.

### DETAILED DESCRIPTION OF THE INVENTION

Hereinbelow, an embodiment of the scanner and the error display method for the same of the present invention will be described with reference to the attached drawings.

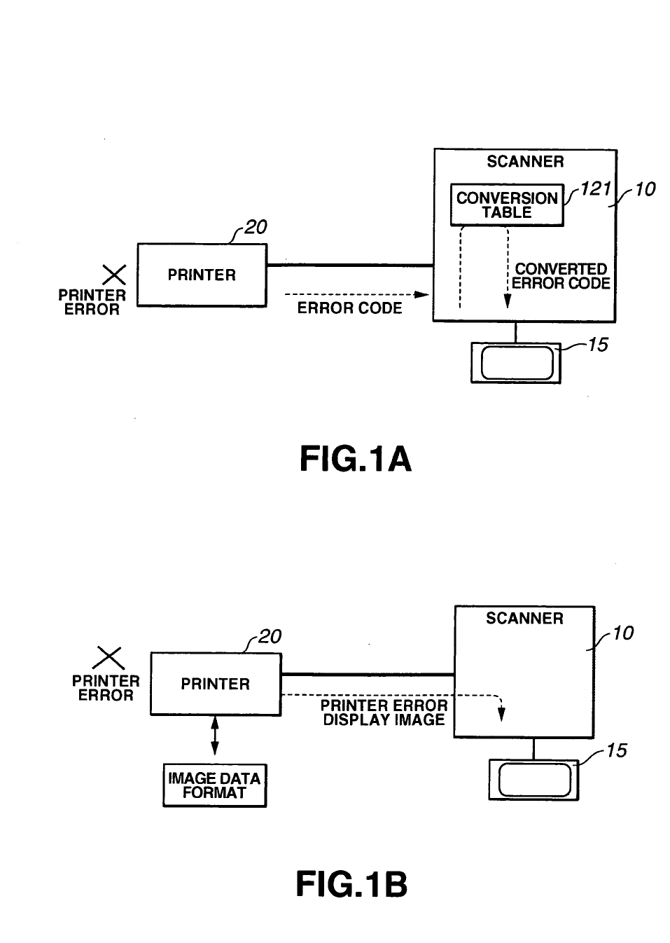

FIG. 1A and 1B are image drawings illustrating the outline of the error display method in the printing system to which the scanner and the error display method for the same of the present invention are applied.

FIG. 1A gives a processing image of the error display wherein a scanner 10 which, in order to carry out error display in correspondence with an error code notified from various printers, manages an error code conversion table 121 for recording and managing the correspondence of the printer error codes defined in the inside of the own apparatus to the error codes notified from the printer for each model, and converts an error code notified from a printer 20 into an internal printer error code for carrying out error display control.

In addition, in FIG. 1A, the printer 20 has means for using an error code to notify the scanner 10 of an error which has occurred in the printer 20, and the scanner 10 has the function with which, when the printer model is a compatible model, but the correspondence relationship with a particular error code notified from the printer 20 is not registered in the error code conversion table 121, the scanner 10 requests the printer 20 to send the error code list, and registers the contents of the received error code list in the error code conversion table 121.

FIG. 1B gives a processing image of the error display wherein the printer 20 sends, to the scanner, error information prepared on the basis of the data format which allows the display control of the scanner to prepare display data with no need for analyzing the content of the error sensed by the printer, and the scanner 10 utilizes the received error information to prepare data for error display for carrying out error display control for a scanner control panel 15.

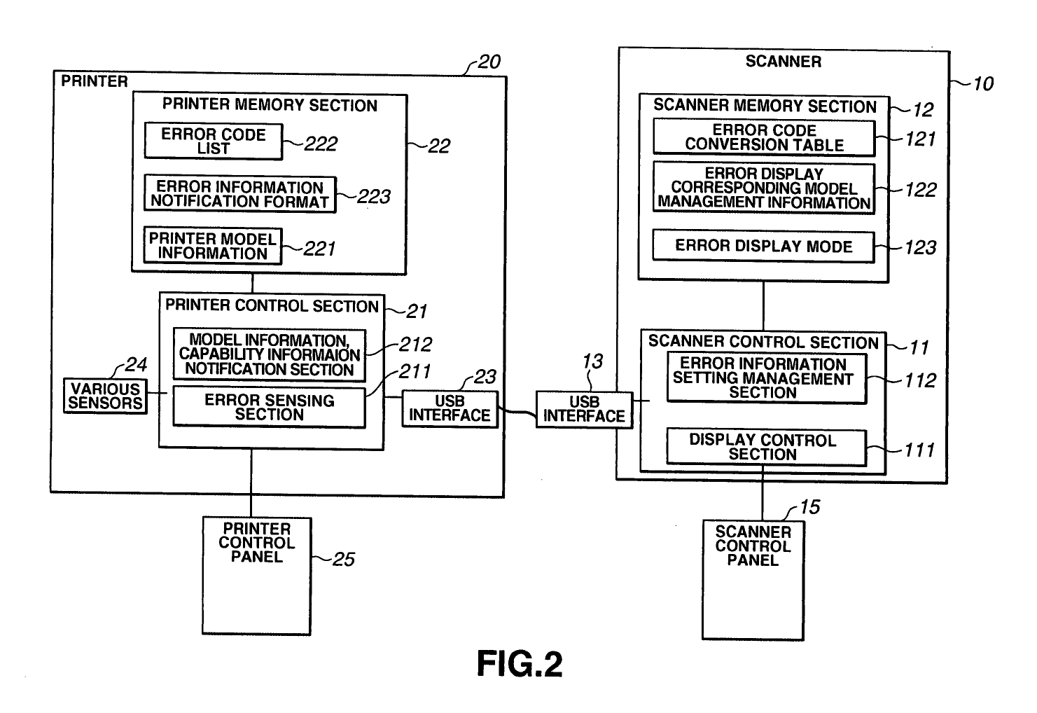

FIG. 2 is a drawing illustrating an example of configuration of the scanner 10 and the printer 20 as shown in FIG. 1A and FIG. 1B.

In FIG. 2, the scanner 10 is configured to comprise a scanner control section 11, a scanner memory section 12, a USB interface (on the scanner side) 13, and a scanner control panel 15.

The scanner control section 11 is connected to the scanner memory section 12, the USB interface (on the scanner side) 13, and the scanner control panel 15 for surprisingly control the entire scanner 10, and includes a display control section 111 which carries out output control to display the operation menu for the scanner, and the printer error on the scanner control panel 15; and an error information setting management section 112 which carries out registration processing of the error code conversion table 121, and error display corresponding model management information 122 which are registered and managed in the scanner memory section 12; carries out control of outputting the option screen for registration and alteration to the scanner control panel 15, or the display section of a personal computer as an external apparatus for the scanner control panel 15; and carries out registration, alteration, or deletion processing of the error code conversion table 121, or the error display corresponding model management information 122 on the basis of the result of input from the operation screen.

The scanner memory section 12 provides memory means for storing the control program and control information for the scanner, and particularly, in order to display the printer error, stores and manages the error code conversion table 121, the error display corresponding model management information 122, and an error display mode 123.

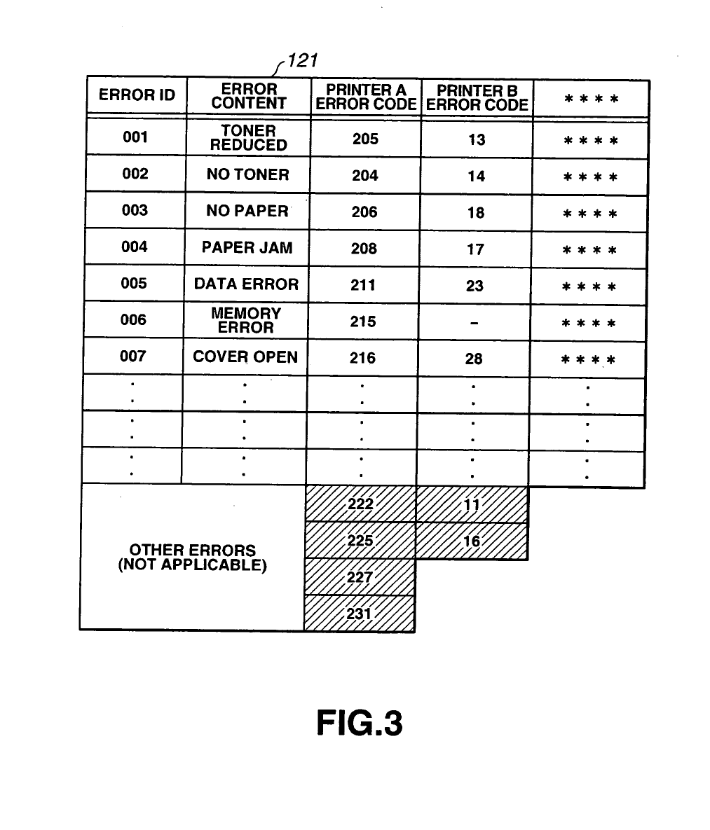

As shown in FIG. 3, the error code conversion table 121 provides the code conversion table for enabling the handling of the error codes, which vary depending upon the model of the printer, with internal codes which are rendered common by arranging them for each content of printer error.

The error code conversion table 121 registers and manages, for each printer model, the error codes for the printer errors corresponding, in content, to the internal codes, i.e., the error codes which can be analyzed in the inside of the scanner 10.

When the error content corresponding to an error ID has not been offered by the printer 20, that error ID is registered, being provided with information indicating “not applicable”.

On the other hand, when any of the error IDs which are managed by the scanner 10 do not correspond to the content of an error code notified by the printer 20, the error code is classified and registered as one of the other errors.

Returning back to FIG. 2, the error display corresponding model management information 122 is information that records and manages, for each of the printer models, either one of the error display control method of carrying out an error display by converting the error code notified from the printer 20 and the error display control method of carrying out an error display by creating a display image based on the error information received from the printer 20, when the scanner 10 displays the content of the printer error occurred in the printer 20.

Thereby, in the connection processing following the bus reset processing, the scanner 10 determines whether the printer model information 221 notified from the printer 20 is registered to the error display corresponding model management information 122, and whether the error display control by the code conversion can be performed.

The error display mode 123 provides the information which is referenced by the scanner 10 to determine, at the time of connection, which of the error display controls as illustrated in FIG. 1A and 1B is to be carried out.

The USB interface 13 provides the communication interface for carrying out data communication, on the basis of the USB Standard, with the printer 20 USB connected.

The printer 20 is configured to comprise a printer control section 21, a printer controller memory section 22, a USB interface 23, various sensors 24 for error detection.

The printer control section 21 surprisingly controls the entire printer 20, and further comprises a model information, capability information notification section 212 which notifies the scanner 10 of a printer model information 221, and an error code list 222, and an error sensing section 211 which USB sends, to the scanner 10, an error detected with the various sensors 24 as a piece of status information including an error code, or a piece of error information.

In addition, the printer control section 21 receives a copying job from the scanner 10 through the USB interface 23, and analyzes the received copying job to prepare a page image to be printed for preparation of intermediate data processable by the print engine section, and carries out printing control by the copying function.

The printer memory section 22 registers and manages the printer model information 221 indicating the model of the printer, and the printer error sensed by the printer 20, and stores and manages the error code list 222, which is notified to the scanner 10 as required, and an error information notification format 223, which provides a data format to be used when the content of an error sensed is to be notified as a piece of error information.

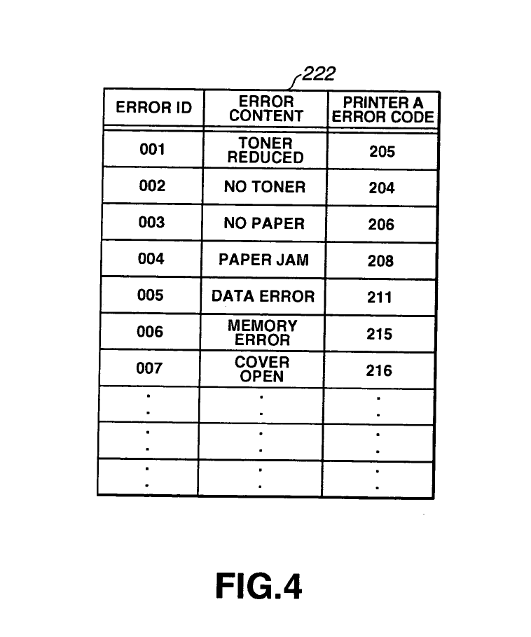

FIG. 4 is a drawing illustrating an example of error code list 222 which is notified to the scanner 10 from the printer 20.

The error sensing section 211 can detect errors at hardware level, such as a paper jam, paper used up, toner used up, and the like, that are sensed by the various sensors 24, and errors at software level that are sensed by the printer control section 21, and acquires the error code applicable to the sensed printer error from the printer error code list 222 to notify it to the printer control section 21.

The USB interface 23 provides the communication interface which is installed between the printer 20 and the scanner 10 connected with the USB cable to detect the power-on, the power reset, and the cable connection/disconnection for carrying out bus reset processing and model information exchange processing, and once the communication channel is established, carries out control of receiving the copying job data from the scanner connected, and sending, thereto, a status response for printing processing of the received copying job.

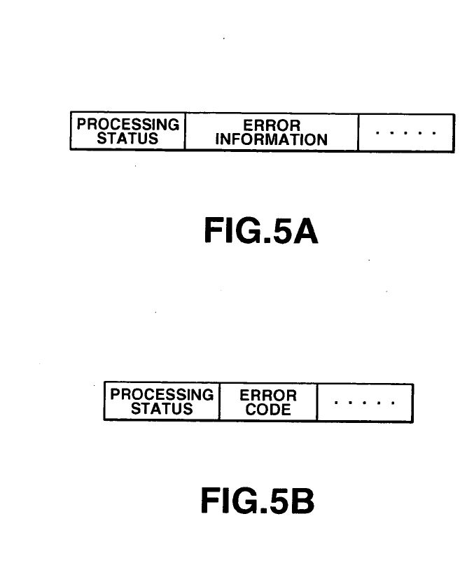

FIG. 5A and FIG. 5B are drawings illustrating examples of status information notified to the scanner 10 from the printer 20.

FIG. 5A gives the data format to be used when the content of a printer error is to be notified as a piece of error information in the data format other than that for the error code, such as text, image data, or the like.

FIG. 5B gives the data format to be used when the content of a printer error is to be notified as a printer error code.

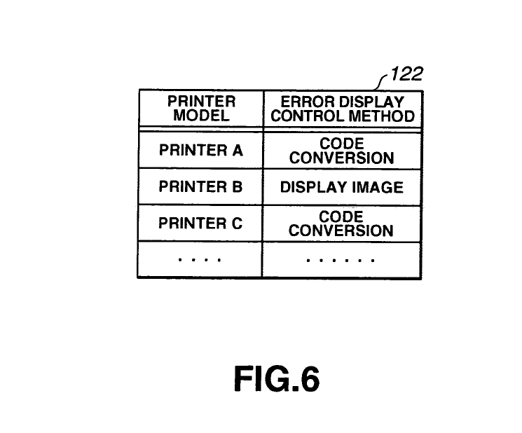

FIG. 6 is a drawing illustrating an example of error display corresponding model management information 122.

The error display corresponding model management information 122 registers and manages the list of printer models which are compatible with the scanner 10 for error display processing, and the information about which of the error display modes as illustrated in FIG. 1A and 1B the respective printers registered in the list are compatible with.

As the “error display control method”, the “code conversion” is entered when the model of the pertinent registered printer 20 is compatible with the error code conversion processing, and the “display image” is registered when the pertinent registered printer 20 is a printer which receives error information and gives an error display.

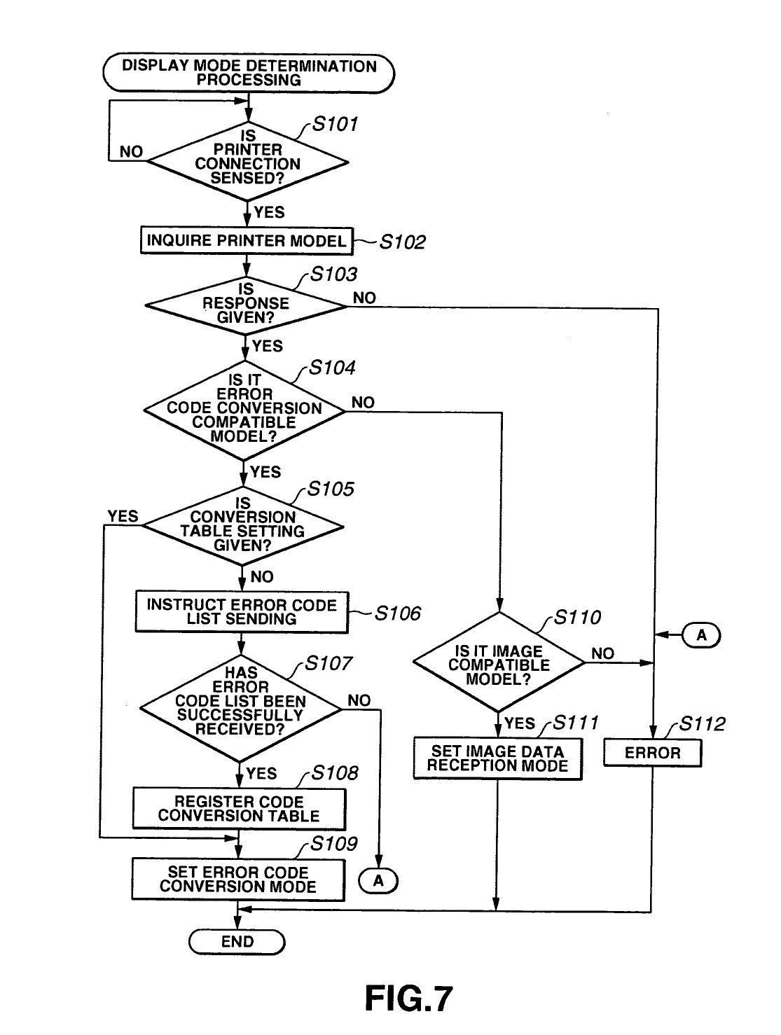

Next, the error display mode determination processing in the scanner 10 which has detected the connection of the printer will be described by using the flowchart as shown in FIG. 7.

When the scanner 10 detects power-on, power reset of the printer 20, and connection of the printer 20 by USB connection (YES at S101), it sends, to the printer 20, command data requesting the printer 20 to notify the printer model information 221 through the USB interface 13 (at S102).

When the printer 20 gives no response on the printer model information 221 (NO at S103), the scanner 10 carries out connection error processing (at S112).

When the printer 20 gives a response on the printer model information 221 (YES at S103), the scanner 10 references the error display corresponding model management information 122 to determine whether the notified model is a model which can give an error display by the error code (at S104).

When the printer 20 is a compatible model which notifies the error by means of an error code (YES at S104), the scanner 10 determines whether the error codes corresponding to the model of the printer 20 connected are registered to the error code conversion table 121 (at S105).

When the error codes for the printer 20 are not registered to the error code conversion table 121 (NO at S105), the scanner 10 sends, to the printer 20, command data instructing the printer 20 to send the error code list 222 through the USB interface 13 (at S106).

When the printer 20 will not notify the error code list 222, or when the reception fails (NO at S107), the scanner 10 carries out connection error processing (at S112).

When the error code list 222 has been successfully received (YES at S107), the scanner 10 registers the contents of the error code list 222 received to the error code conversion table 121 (at S108), and sets the error “code conversion” mode in the error display mode 123.

Again at step S 105 for determination processing, when the error codes corresponding to the printer model information notified have been registered to the error code conversion table 121 (YES at S105), the scanner 10 sets the error “code conversion” mode in the error display mode 123 (at S109).

In addition, at step S104, when the model information for the printer 20 that is set in the error display corresponding model management information 122 indicates that it is compatible with the “display image” (NO at S104, YES at S110), the scanner 10 sets the “display image” mode in the error display mode 123 (at S111), and when the model notified by the printer 20 is a model which is not registered in the error display corresponding model management information 122 (NO at S110), the scanner 10 carries out the connection error processing (at S112).

Next, the operation of the printer error display by the scanner 10 will be described.

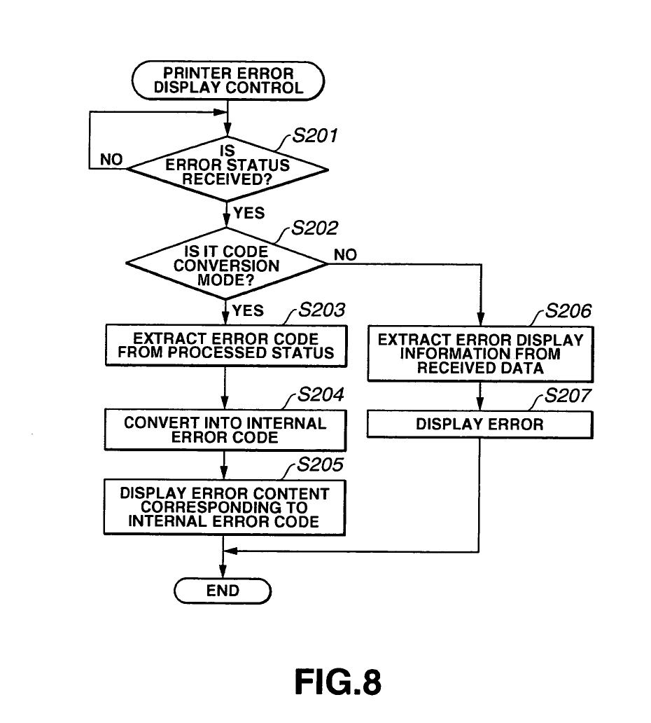

FIG. 8 is a flowchart illustrating an example of operation of the printer error display processing after the error display mode having been established, with the USB connection processing having been implemented.

When the scanner 10 senses the occurrence of a printer error by the status information notified from the printer 20 (YES at S201), it carries out determination of the error display mode (at S202); when the error display mode is the “code conversion” mode (YES at S202), the scanner 10 extracts the printer error code from the status information notified by the printer (at S203), and on the basis of the error code conversion table 121, converts the extracted error code into an error ID which can be handled by the display control section 111 of the scanner 10 (at S204), then displaying the error content corresponding to the error ID on the display section of the scanner control panel (at S205).

Again at step S202 for processing, when the error display mode is the “display image” mode (NO at S202), the scanner 10 extracts the error information from the status information (at S206), and on the basis of the error information extracted, displays the printer error on the scanner control panel 15 (at S207).

As stated above, a first aspect of the present invention provides a scanner which is network connected or locally connected to a printer, and outputs a read-out image to the printer as a copying job for carrying out a printing request, and which includes: an error display section; an error code acquisition section which acquires from the printer a printer model-specific error code set for each model of the printer, an error code conversion section which converts the error code acquired by the error code acquisition section into error information which can be displayed on the error display section; and a display control section which, on the basis of the error information converted by the error code conversion section, displays an error occurred in the printer on the error display section.

A second aspect of the present invention is the scanner of the first aspect of the invention in which the error code conversion section may have one or a plurality of error code conversion tables which previously store a corresponding relationship between the printer model-specific error code and the error information which can be displayed on the error display section in correspondence with each printer, and on the basis of the model information and the error code for the printer that have been acquired from the printer, may convert the printer model-specific error code into the error information which can be displayed on the error display section.

A third aspect of the present invention provides a scanner which is network connected or locally connected to a printer, and outputs a read-out image to the printer as a copying job for carrying out a printing request, and which includes: an error display section; an error display information acquisition section which acquires, from the printer, error display information which is displayed on the basis of the printer model-specific error code which has been set in the printer for each model of the printer; and a display control section which, on the basis of the error information acquired by the error display information acquisition section, displays an error occurred in the printer on the error display section.

A fourth aspect of the present invention provides an error display method for a scanner which is network connected or locally connected to a printer, and outputs a read-out image to the printer as a copying job for carrying out a printing request, the method includes: acquiring from the printer, by using an error code acquisition section, a printer model-specific error code set for each model of the printer, converting, by using an error code conversion section, the error code acquired by the error code acquisition section into error information which can be displayed on an error display section; and on the basis of the error information converted by the error code conversion section, displaying by using a display control section an error occurred in the printer on the error display section.

A fifth aspect of the present invention provides an error display method for a scanner which is network connected or locally connected to a printer, and outputs a read-out image to the printer as a copying job for carrying out a printing request, the method includes: acquiring from the printer, by using an error display information acquisition section, error display information which is displayed on the basis of the printer model-specific error code which has been set in the printer for each model of the printer, and on the basis of the error information acquired by the error display information acquisition section, displaying by using a display control section an error occurred in the printer on the error display section.

According to the scanner and the error display method for the same of the present invention, the content of the printer error can be displayed on the display section of the scanner, even when the type of the printer connected is different and the error code notified is different.

Thereby, the user can detect, on the scanner side, whether the trouble which has occurred when the copying function of the scanner is used is due to the scanner side or the printer side.

The scanner and the error display method for the same of the present invention is applicable to any printing system which is configured to comprise a scanner and a printer, and particularly to any scanner having the copying function wherein the error display function displays the content of a printer error which has occurred in the copying processing.

The foregoing description of the embodiment of the present invention has been provided for the purpose of illustration and description. It is not intended to be exhaustive or to limit the invention to the precise forms disclosed Obviously, many modifications and variations will be apparent to practitioners skilled in the art. The embodiment was chosen and described in order to best explain the principle of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-276028 filed on Sep. 22, 2005 including specification, claims, drawings and abstract is incorporated herein by reference in its entirety.

What is claimed is:

1. A scanner which is network connected or locally connected to a printer, and outputs a read-out image to the printer as a copying job for carrying out a printing request, comprising:
an error display section;
an error code acquisition section which acquires from the printer a printer model-specific error code set for each model of the printer,
an error code conversion section which converts the error code acquired by the error code acquisition section into error information which can be displayed on the error display section; and
a display control section which, on the basis of the error information converted by the error code conversion section, displays an error occurred in the printer on the error display section.

2. The scanner of claim 1, wherein the error code conversion section has one or a plurality of error code conversion tables which previously store a corresponding relationship between the printer model-specific error code and the error information which can be displayed on the error display section in correspondence with each printer, and on the basis of the model information and the error code for the printer that have been acquired from the printer, converts the printer model-specific error code into the error information which can be displayed on the error display section.

3. A scanner which is network connected or locally connected to a printer, and outputs a read-out image to the printer as a copying job for carrying out a printing request, comprising:
an error display section;
an error display information acquisition section which acquires, from the printer, error display information which is displayed on the basis of a printer model-specific error code which has been set in the printer for each model of the printer; and
a display control section which, on the basis of the error information acquired by the error display information acquisition section, displays an error occurred in the printer on the error display section.

4. An error display method for a scanner which is network connected or locally connected to a printer, and outputs a read-out image to the printer as a copying job for carrying out a printing request, the method comprising:
acquiring from the printer, by using an error code acquisition section, a printer model-specific error code set for each model of the printer;
converting, by using an error code conversion section, the error code acquired by the error code acquisition section into error information which can be displayed on an error display section; and
on the basis of the error information converted by the error code conversion section, displaying by using a display control section an error occurred in the printer on the error display section.

5. An error display method for a scanner which is network connected or locally connected to a printer, and outputs a read-out image to the printer as a copying job for carrying out a printing request, the method comprising:
acquiring from the printer, by using an error display information acquisition section, error display information which is displayed on the basis of a printer model-specific error code which has been set in the printer for each model of the printer, and
on the basis of the error information acquired by the error display information acquisition section, displaying by using a display control section an error occurred in the printer on the error display section.
